(19) United States
(12) Patent Application Publication
(10) Pub. No.: US 2026/0322088 A1
(43) Pub. Date: Oct. 15, 2026

(54) ELECTRICAL DEVICE

(71) Applicant: Ellenberger & Poensgen GmbH, Altdorf (DE)

(72) Inventors: Herbert ROTH, Altdorf (DE); Tobias PREM, Neumarkt (DE)

(73) Assignee: Ellenberger & Poensgen GmbH, Altdorf (DE)

(21) Appl. No.: 19/700,599

(22) Filed: Jun. 8, 2026

Related U.S. Application Data
(63) Continuation of application No. PCT/EP2024/080142, filed on Oct. 24, 2024.

(30) Foreign Application Priority Data
Dec. 8, 2023 (DE) 10 2023 212 415.7

(51) Int. Cl. H02G 3/08; H01R 9/24; H02G 3/16

(52) U.S. Cl. CPC H02G 3/088; H01R 9/2491; H02G 3/081; H02G 3/16

(57) ABSTRACT

An electrical device comprising a housing and a functional component. The functional component is arranged in the housing. The functional component comprises a bushing. The housing has an opening which covers the bushing, with the opening being lined with a sealing element. An assembly is also provided.

This nonprovisional application is a continuation of International Application No. PCT/EP 2024/080142, which was filed on Oct. 24, 2024, and which claims priority to German Patent Application No. 10 2023 212 415.7, which was filed in Germany on Dec. 8, 2023, and which are both herein incorporated by reference.

### BACKGROUND OF THE INVENTION

### Field of the Invention

The invention relates to an electrical device, which comprises a housing and a functional component arranged therein. The invention further relates to an assembly, which includes two electrical devices.

### Description of the Background Art

Distribution boxes or control cabinets are usually used to connect a wide variety of actuators. An infeed module or power supply is generally arranged therein, which is connected to a main line guided in the distribution box. Multiple electrical devices are, in turn, electrically contacted by means of the infeed module. Multiple busbars are usually present in the distribution box (distribution cabinet), with the aid of which the corresponding electrical devices, such as circuit breakers, switches, or fuses, are electrically contacted. Secondary circuits are electrically connected to the main line via the electrical devices, the actuators being assigned to the secondary circuits. A control of the electrical current conducted by means of the particular secondary circuit is made possible with the aid of the electrical devices. The distribution cabinet usually comprises a door, which is lockable and via which a mounting and/or operation of the individual electrical devices arranged inside the distribution cabinet is made possible. An unauthorized access is prevented by means of the door, and a contact protection is also implemented. A requirement for a contact protection or the like of the individual electrical devices is thus comparatively low.

If the connection takes place in a comparatively unprotected environment, such as in an outdoor region, it is necessary for it to meet a certain protection class, usually IP 65 or IP 67. The distribution box is usually designed according to the protection class, since the elements arranged therein, such as the busbars, are comparatively unprotected. It is thus necessary to design the individual cutouts for the main connection as well as for the secondary circuits according to the protection class desired in each case. It is also necessary to design the door according to the protection classes, for which purpose circumferential sealing elements are generally provided. In order for the doors to abut the sealing elements in a force-fitting manner, it is necessary, in turn, for the door to be provided with a comparatively stable design, which results in increased costs as well as an increased weight. The mounting of the individual electrical devices within the distribution box is also comparatively time-consuming. After an opening of the door, for example for the purpose of a maintenance and/or a reconfiguration of the interconnection, it must also always be ensured that the tightness is again achieved.

### SUMMARY OF THE INVENTION

It is therefore an object of the present invention to provide a particularly suitable electrical device as well as a particularly suitable assembly, a mounting being expediently simplified and a safety being expediently increased.

The electrical device can include a housing and a functional component, which is arranged in the housing. The housing is advantageously manufactured, at least in part, from a plastic or a metallic material, and a protection of the functional component is preferably implemented by this means. in particular, at least one or all functions of the electrical device is/are provided with the aid of the functional component. The functional component is designed, in particular, in such a way that the corresponding function is implemented during operation. The electrical device, in particular the functional component, advantageously includes one or multiple electrical/electronic components for this purpose. The functional component suitably includes one or multiple printed circuit boards, on which the corresponding components are fastened, preferably soldered. The mounting is thus simplified and a robustness increased.

In summary, an electrical function can be carried out during operation with the aid of the electrical device. The electrical device comprises, for example, one or multiple electronic components, or it advantageously includes only electrical components. In summary, the electrical device is used to carry out an electrical function, in particular, the influencing of an electrical current and/or an electrical voltage, for which purpose the functional component is correspondingly designed.

In particular, the electrical device can be a circuit breaker or another protective element. The electrical device in particular the functional component, comprises a switching element, which is actuated depending on certain conditions, such as a fault current, an overcurrent, and/or an overvoltage. The circuit breaker is provided, for example, only with a mechanical or electrical design. In particular, the switching element is designed either as a relay or a semiconductor switch. In one refinement, the circuit breaker is designed as a combination of a mechanical and an electrical circuit breaker.

The electrical device can be used to provide functional safety and is thus, in particular, a so-called “safety component.” In a further alternative, the electrical device is, for example, an infeed module, a switched-mode power supply, a relay, a protective element, a switching device, a bus system/communication system component, a buffer component, a potential distributor, a power distributor, a miniature circuit breaker, or an I/O module. Depending on the design of the electrical device, the functional component is adapted so that the desired functionality is implemented.

For example, the electrical device can be an individual device, which is provided, for example, with a single-pole or multipole design, in particular if designed as a circuit breaker. In one alternative, the electrical device is designed as a series device, which is, for example, a single-pole or multipole device. The electrical device is advantageously a series-connectable electrical switching device or a series built-in device.

The functional component can include a bushing. The bushing is thus arranged within the housing. The bushing is, in particular, electrically conductive and suitably electrically contacted to further constituent parts of the functional component, advantageously the possible electrical component and/or the possible printed circuit board, preferably a printed conductor of the printed circuit board. In particular, the bushing is manufactured from a metal, for example, a copper, brass, or aluminum. The bushing is provided, in particular, with a hollow cylindrical design.

The housing can have an opening which covers the bushing. The bushing is advantageously provided with a round design. In particular, the opening is concentric to an axis of the bushing, or at least the axis of the bushing penetrates the opening. The opening and the bushing are advantageously offset from each other in parallel to the axis. For example, the size of the opening is equal to the size of the bushing, or one of them is larger. In summary, the bushing and the opening are arranged in such a way that an insertion of a contact element through the opening into the housing is possible from outside the housing, the contact element being inserted into the bushing along the axis thereof during a further movement.

The opening can be lined with a sealing element. In particular, the sealing element is designed in the manner of an O-ring and is advantageously formed with the aid of an O-ring or at least comprises the latter. For example, the sealing element has one or multiple sealing lips. The sealing element is suitably manufactured from a rubber or elastomer, and the sealing element is provided, in particular, with a round design. The sealing element is advantageously provided with a circumferential design, and it directly abuts the housing, for example in a mechanical manner.

Due to the opening, the contacting of the bushing, and thus the functional component, from outside the housing is made possible, it being possible, due to the arrangement, to insert the contact element through the opening so that it enters the bushing. A mounting is thus comparatively easy. Due to the sealing element, a tightness is provided, so that a penetration of foreign particles and/or a liquid via the opening is prevented in the mounted state. A safety is thus increased. It is also possible to change the connection of the electrical device to further components by correspondingly replacing the contact element, so that a maintenance and reconfiguration are made easier. A size of the sealing element is furthermore comparatively small, and it may be provided with a comparatively compact and weight-saving design, so that a weight and manufacturing costs are reduced. The electrical device suitably meets the requirements according to IP 65 or IP 67 in the mounted state, in particular when the possible contact element is mounted. In particular, the housing, the sealing element, and/or the possible contact element are designed for this purpose.

In particular, the electrical device can include multiple bushings of this type and corresponding openings, each of the openings being lined with a corresponding sealing element. In particular, the openings, bushings, and/or sealing elements are of the same design, so that manufacturing costs are reduced. Due to the plurality of openings, it is possible to carry out different functions with the aid of the electrical device. In particular, electrical potentials, and/or, for example, electrical ground, are arranged such that they are assigned, at least in part, to the different bushings/openings. Alternatively or in combination therewith, the bushing or at least one of the bushings is used for the signaling connection to one or further additional component(s).

The contact element, which is inserted into the opening, can be preferably present. The contact element thus extends into the housing from the outside. For example, the contact element is situated at a distance from the sealing element or abuts it via a further constituent part. However, the contact element particularly preferably directly abuts the sealing element in a mechanical manner, the sealing element being, for example, at least partially elastically deformed so that a sealing effect is improved. The contact element is suitably situated in the bushing, so that, for example, an electrical contacting of the bushing with the aid of the contact element takes place, in particular if the contact element is at least partially electrically conductive. However, the contact element is thus at least additionally stabilized with the aid of the bushing.

For example, the contact element can be a constituent part of a sealing plug, which is, in particular, electrically non-conductive, either in its entirety or at least the portion situated outside the housing. The sealing plug is advantageously made from a single piece and preferably from the plastic. The opening is closed with the aid of the sealing plug, so that a penetration of foreign particles into the housing via the opening is prevented even when the bushing is not used. In one alternative, the contact element is, for example, a constituent part of a plug-in jumper, which is designed to be at least partially electrically conductive. The electrically conductive part is situated at least partially in the bushing and is guided out of the housing via the opening, so that an electrically contacting of the functional component from outside the housing is made possible. By replacing or adapting the plug-in jumper and/or exchanging it for the sealing plug, it is possible to change a connection of the electrical device to further components without a comparatively comprehensive modification of the device being necessary per se. In particular, an additional creation of passages through the housing is also not necessary. It is furthermore possible, for example during a reconfiguration, to close off, an opening which is not (or no longer) used for electrical contacting with the aid of the sealing plug, which comprises the correspondingly designed contact element or is formed with the aid thereof, so that a tightness is again achieved, which results in a protection of the functional component. The invention further relates, in particular, to a sealing plug of this type as well as a corresponding plug-in jumper.

For example, the contact element can be provided with a multi-part design, and it has, for example, a main body, which is surrounded by a metal jacket on the circumferential side, in particular in the region of the sealing element. A robustness is thus increased. However, the contact element preferably comprises a plastic body, which abuts the sealing element. A damage to the sealing element during the insertion of the contact element into the opening is thus prevented. For example, the contact element is formed with the aid of the plastic body, in particular if the latter is designed as a sealing plug or is a part thereof. If the contact element is a constituent part of the plug-in jumper, a metallic pin, in particular, is surrounded by the plastic body, at least in sections, a free end of the pin being situated in the bushing in the mounted state. The pin is advantageously formed by an end of a U-shaped conductor, the other end advantageously also forming a pin of a further contact element. The plug-in jumper thus includes two contact elements, a portion of the conductor being assigned to both of them. The two free ends of the conductor, namely the particular pins, are each situated in one bushing of two different corresponding electrical devices, the conductor being guided in each case through one of the openings of the two electrical devices. In particular, the plastic body is assigned in each case to the two contact elements of the plug-in jumper, which are preferably formed onto each other, and by means of which the part of the conductor arranged at least outside the two housings is surrounded. The plastic body is advantageously electrically isolating, so that a contact protection is implemented. In an example, a body which is made from a glass or a ceramic is used in each case instead of the plastic body.

For example, the outer diameter of the contact element, in particular outside the housing, can be equal to the diameter of the opening. A weight is thus reduced. However, the contact element particularly preferably has a collar, which projects over the opening and abuts the housing on the outside. In other words, the diameter of the contact element is larger than the diameter of the opening, at least in the region of the collar. An insertion of the contact element too far into the opening is prevented by the collar, which, on the one hand, could result, for example, in a destruction of or damage to the function component, such as a detachment of the bushing from the possible printed circuit board. On the other hand, a type of labyrinth seal is provided by the direct contact with the housing, for which reason a tightness is further increased and a requirement for the sealing element is reduced. Manufacturing costs are thus reduced. In particular, the collar is a constituent part of the possible plastic body, so that a construction and manufacturing are simplified.

For example, the contact element can rest only loosely in the bushing or the opening, and it is stabilized and held in the desired position, for example, only with the aid of the sealing element. However, the contact element is particularly preferably held on the housing, where it is fastened, in particular, in a detachable manner. In this way, the contact element itself is stabilized with the aid of the housing, not only with the aid of the sealing element, which increases a robustness. In particular, if the collar or other structural measures is/are present, a sealing effect is also improved in this way. In particular, a force fit between the contact element and the housing or at least a further constituent part of the electrical device is implemented by means of the detachable fastening, which increases a tightness. Due to the detachable fastening, a change in the connection of the electrical device to further components is always possible later on.

For example, the contact element can be screwed to the housing. However, the contact element is particularly preferably latched to the housing. An establishment of the mechanical connection therebetween is thus made easier and, in particular, without a tool, which reduces the mounting time and makes mounting easier. For example, the contact element includes multiple latching elements. The housing particularly preferably comprises a latching tongue, with the aid of which the contact element is latched. When the contact element is guided through the opening, in particular situated in the bushing, the contact element, preferably the possible plastic body, is engaged from behind with the aid of the latching tongue, so that a force fit is implemented between the contact element and the outside of the housing. An unintentional detachment of the contact element is avoided in this way. A construction of the contact element is made easier by the engagement from behind. A release of the latching connection is also made easier, since the latching tongue is essentially freely accessible. Since the housing includes the latching tongue, a weight of the contact element is also reduced, so that a mounting is made easier. It is also possible to provide the latching tongue with a comparatively robust design and to design it with a comparatively large engagement from behind without a mechanical integrity of the contact element being reduced. In one alternative, the contact element has, for example, a groove or a notch, in which the latching tongue is situated on the end side.

For example, the sealing element can be injected into the housing and, during the manufacturing of the electrical device, a plastic is injected around the sealing element, with the aid of which the housing is subsequently formed. Alternatively, for example, an inner wall of the opening has a groove or a trough, into which the sealing element is inserted during manufacturing. However, the housing particularly preferably comprises a housing upper part, which comprises an indentation. The sealing element is inserted into the indention, and the indentation is, in particular, completely filled with the sealing element. The housing also includes a cover element, which is advantageously manufactured from a plastic, preferably from the same material as the housing upper part. The sealing element is covered by the cover element, and the cover element is fastened on the housing upper part. The sealing element is thus situated at least partially between the housing upper part and the cover element, and the opening is formed in each case with the aid of the latter. Due to the cover element, the sealing element is thus protected, which increases a robustness. In addition, there are no limitations regarding the design of the sealing element, and the latter may be designed to be comparatively inelastic and/or of a large size, a comparatively easy mounting nevertheless being made possible.

For example, the cover element can be welded to the housing upper part or is preferably glued thereon, which makes a manufacturing easier. The latching tongue or another latching element is preferably present, with the aid of which the contact element is latched in the mounted state. The latching element is advantageously fastened on the cover element, preferably molded thereon and forming a single piece therewith. For example, in the case of a damage to the latching element, such as the latching tongue, it is necessary only to replace the cover element but not the entire housing upper part. For example, the indentation is situated on a side of the housing upper part facing the surroundings, i.e., in particular, on the outside. In this way, a manufacturing is made easier, in particular the attachment of the sealing element as well as the cover element. Alternatively, the indentation and the cover element are arranged on the side of the housing upper part facing the interior, in particular on the inside. They are thus protected by means of the housing upper part, which increases a robustness.

For example, the cover element can rest on the housing upper part and thus projects over it. However, the housing upper part particularly preferably has a well, into which the indentation is introduced. The cover element is situated in the well. A detachment of the cover element is thus avoided, even if the housing bumps into further components, and the cover element is at least partially protected. The well is particularly preferably completely filled by the cover element, which increases a robustness and a tightness. In particular, the cover element is flush with an upper side of the housing part, for which reason a damage, such as a detachment of the cover element from the housing upper part, is essentially avoided, even if the housing is used in a manner other than intended.

If multiple openings are present, a corresponding cover element can be assigned, for example, to each of the openings. However, the same cover element is particularly preferably assigned to all openings and all sealing elements, multiple openings thus being formed with the aid of the cover element. A manufacturing is thus simplified. The well is preferably present, and all indentations are introduced into the well.

For example, the housing is provided with a one-part design, or is at least circumferentially closed, and it is manufactured, in particular, after the arrangement of the functional component. However, the housing particularly preferably comprises a housing shell, which is provided, in particular, with a cup-shaped design. The housing shell, in turn, is closed with the aid of a cover, which is fastened on the housing shell. An arrangement of the functional component is made possible by removing the cover from the housing shell or at least prior to fastening the cover to the housing shell, which makes manufacturing easier. For example, the cover is non-detachably connected to the housing shell, for example welded, which improves a tightness. However, the cover is particularly preferably detachably arranged on the housing shell, so that a subsequent inspection, a replacement, and/or a repair of the functional component is made possible. The cover is preferably screwed to the housing shell, for which purpose, in particular, one, preferably multiple, screw(s) is/are used.

A further sealing element, preferably an O-ring, can be suitably arranged between the cover and the housing shell, so that a tightness is also implemented despite the detachable connection. In particular, the cover has a circumferential groove, into which the O-ring is inserted, so that the latter is not shifted or detached during the mounting of the cover on the housing shells. For example, the housing upper part is present, which is formed, for example, with the aid of the cover. However the housing upper part is particularly preferably formed with the aid of the housing shell, and the housing upper part is formed with the aid of the base of the cup-shaped housing shell, or the latter at least comprises the base. For example, the opening is introduced into the base of the housing shell and/or on a side of the housing shell opposite the cover. An arrangement of the functional component is thus simplified, in particular if the latter comprises a printed circuit board.

The housing shell can comprise a power connection or the like, which is introduced into a wall of the housing shell. The power connection comprises, in particular, a passage, into which a cable is placed or at least plugged in. The power connection is preferably electrically contacted with the functional component, so that an electrical contacting of the functional component is made possible here as well.

The assembly can include two electrical devices, which each include a housing having a functional component arranged therein. Each functional component comprises a bushing, and the particular housing has an opening, which covers the bushing assigned in each case. Each opening is lined with a sealing element. For example, the functional components of the two electrical devices are the same, or they differ from each other.

The functional components can be electrically connected with the aid of a plug-in jumper, which includes two contact elements. Each contact element has one metallic pin, which are each guided through one of the openings. In particular, one of the contact elements in each case is a constituent part of the electrical device through whose opening it is guided, the contact element being detachably connected to the further constituent parts of the particular electrical device. Each pin is inserted into the assigned bushing on the end side, and the two pins are electrically connected to each other outside the two housings. The pins are preferably formed by a shared, essentially U-shaped, conductor. In the region arranged outside the housing, the conductor is advantageously surrounded by a plastic, by means of which a plastic body of the particular contact element is at preferably at least partially formed in each case. The plastic body is advantageously electrically isolating, so that a contact protection is implemented. In one alternative, a glass or a ceramic is used instead of the plastic.

The two electrical devices can abut each other and are advantageously stabilized on each other, which increases a robustness. The electrical devices, preferably their housings, are suitably of the same design, for which reason equivalent parts may be used. For example, however, each electrical device has only a single opening. Alternatively, for example, multiple corresponding openings are present. One or multiple openings of one of the housings and one opening of the other housing each advantageously form a pair, to which a corresponding plug-in jumper is assigned in each case. For example, one or multiple of the openings is/are closed in each case by means of a sealing plug, so that the bushings of the electrical devices assigned to these openings are not electrically contacted to each other.

For example, the assembly can comprise only the two electrical device or multiple electrical devices. In particular, further electrical devices may be flexibly added to the assembly. To change the interconnection, in particular, a contact element which is formed with the aid of a sealing plug is replaced with a contact element which is a constituent part of a plug-in jumper, or vice versa. The assembly preferably forms a current distribution system, at least in part.

The refinements and advantages explained in connection with the electrical device are to be similarly transferred to the assembly/the sealing plug/the plug-in jumper as well as to each other and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a perspective view of an assembly including multiple electrical devices;

FIG. 2 shows a perspective view in an exploded representation of one of the electrical devices;

FIG. 3 shows a perspective view of a sealing plug, which forms a contact element;

FIG. 4 shows a perspective view of a plug-in jumper, which includes two modified contact elements; and

FIG. 5 shows a detail of the assembly in a sectional representation.

### DETAILED DESCRIPTION

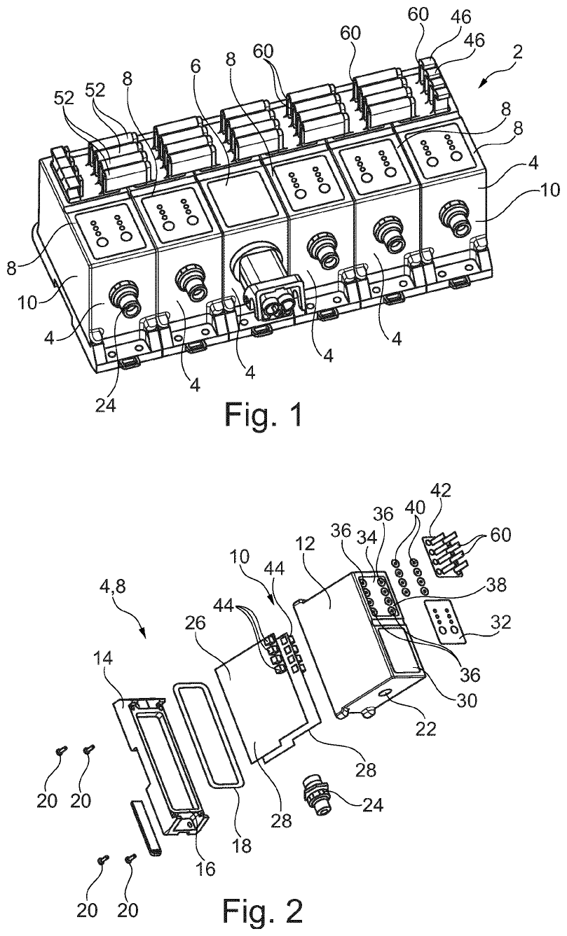

An assembly 2 is illustrated in a perspective view in FIG. 1, which includes a total of six electrical devices 4. One of electrical devices 4 is an infeed module 6, and remaining electrical devices 4 are circuit breakers 8. A series is formed by electrical devices 4, infeed module 6 being arranged essentially in the middle. Assembly 2 forms a current distribution system.

Electrical devices 4 are provided with essentially the same design, and an exploded representation of one of electrical devices 4, namely one of circuit breakers 8, is illustrated in an exploded representation in FIG. 2. Electrical device 4 includes an essentially cuboid housing 10, which has a cup-shaped housing shell 12. The latter is manufactured from a plastic, and the opening of housing shell 12 is closed with the aid of a cover 14. Cover 14 is made from the same plastic and has a circumferential groove 16 on the side facing housing shell 12. A further sealing element 18, namely an O-ring, which is provided with an essentially rectangular design, is inserted into groove 16 and is situated on the end face of the opening in housing shell 12. In an example, further sealing element 18 is injected into housing 10. The fastening of cover 14 on housing shell 12 takes place with the aid of multiple screws 20. In an example, other connecting techniques are used, for example, a snap-on connection. In summary, housing 10 thus includes housing shell 12, which is provided with a cup-shaped design, and thus comprises the opening. In other words, housing shell 12 has the opening, which, in the mounted state, is closed by means of cover 14, which is fastened on housing shell 12 with the aid of screws 20.

A cutout 22 is introduced into a wall of housing shell 12 adjacent to cover 14, int which a power connection 24 is inserted. Power connection 24 is used to connect a functional component 26 arranged inside housing 10 to an electrical cable. In the case of circuit breaker 8, the cable is connected to a secondary circuit, which is protected with the aid of circuit breaker 8 assigned in each case. In the case of infeed module 6, the cable represents a main power connection, with the aid of which power is supplied to the secondary circuits.

In the illustrated example, functional component 26 includes two printed circuit boards 28, on which multiple electrical and/or electronic components are fastened and with the aid of which they are connected. The two printed circuit boards 28 are electrically contacted to power connection 24. The particular function of electrical device 4 is provided with the aid of functional component 26, in particular the connections implemented by means of printed circuit boards 28. In the case of circuit breaker 8, printed circuit boards 28 include a switching element, which is actuated when a certain electrical current is exceeded, in particular an overcurrent or a short-circuit current, so that power connection 24 is electrically separated from further constituent parts of printed circuit board 28. In the case of infeed module 6, a current distribution is provided with the aid of printed circuit boards 28.

A housing upper part 29, which is formed on the further walls of housing shell 12, represents the side of housing shell 12 opposite cover 14, namely the base of housing shell 12. A further opening 30 is introduced into housing upper part 29, into which an indicator element 32 is inserted. A status of functional component 26 is signaled to a user by means of indicator element 32 during operation, so that the status of the functional component may be requested from outside housing 10. In an example, indicator element 32 includes an actuating element, such as a pushbutton, alternatively to or in combination with the status indicators, so that an (integrated) functional element is formed.

An essentially rectangular well 34 is also introduced into housing upper part 29 on the outside, which represents a reduction of the wall thickness. A total of eight indentations 36, in turn, are introduced into well 34, which run in two rows. Indentations 36 are ring-shaped and represent a further reduction of the wall thickness. Indentations 36, which are of the same design, each surround an opening 38, which are each circular. A sealing element 40, namely an O-ring, is inserted into each of indentations 36. The upper side of sealing elements 40 is flush with the base of well 34, due to indentations 36.

A cover element 42 is inserted into well 34, which is manufactured from the same plastic as housing upper part 29 and with the aid of which all sealing elements 40 are covered. Entire well 34 is filled with cover element 40, and the latter is flush with housing upper part 29 on the outside. In summary, housing 10, namely housing shell 12, thus includes housing upper part 29 having well 34, into which indentations 36 are introduced. One of sealing elements 40 is inserted into each indentation 36, and they are covered with the aid of cover element 42, which sits in well 34. Cover element 42, in turn, is fastened on housing upper part 29 with the aid of adhesive. Cutouts are also present in cover element 42, so that openings 38 are formed thereby and are congruent with the corresponding parts of housing upper part 29.

Each of openings 38 covers a bushing 44 of functional component 26. Bushings 44 are of the same design and made from a metal. In each case, four of bushings 44 are fastened on one of printed circuit boards 28 and electrically connected to the electrical/electronic components arranged thereon. Bushings 44 are essentially hollow cylindrical and have an axis, which, in the mounted state, projects in each case through one of openings 38, which is concentric to the axis. In summary, each of openings 38 covers one of bushings 44, and openings 38 are each lined with one of sealing elements 40.

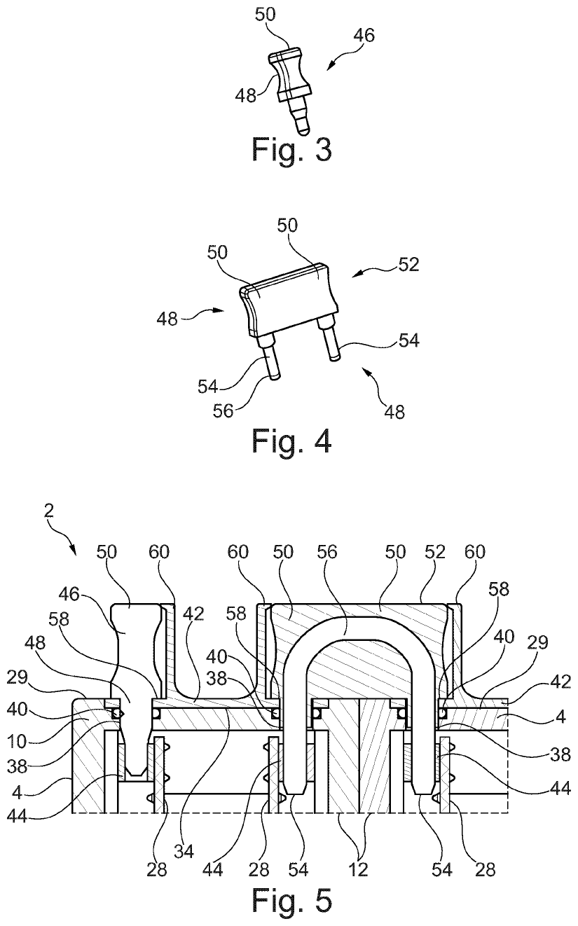

FIG. 3 shows a perspective view of a sealing plug 46, which is formed by a contact element 48. Contact element 48 is made up of a plastic body 50 and a plastic injection-molded part.

A plug-in jumper 52 is illustrated in a perspective view in FIG. 4, which includes two metallic pins 54, which are in parallel to each other and which are each a constituent part of a correspondingly designed contact element 48. In other words, plug-in jumper 52 includes two contact elements 48, which each comprise one of pins 54, as well as plastic body 50 in each case, which, however, form a single piece with each other. The two pins 54 are formed by a conductor 56, which is provided with a U-shaped design, and which is partially embedded in plastic body 50.

A detail of assembly 2 is illustrated in an enlarged sectional view in FIG. 5, namely a detail of two of electrical devices 4 arranged one next to the other on the edge side. In each case, one side of the two housing shells 12 mechanically abuts the other, and the two housing upper parts 29 are arranged in a common plane. Printed circuit boards 28 of the two electrical devices 4 are arranged in parallel to each other, and also the rows of indentations 36 or openings 38.

One of pins 54 of the same plug-in jumper 52 is guided in each into the two directly adjacent openings 38 of directly adjacent electrical devices 4 and inserted into bushing 44 assigned in each case. As a result, these bushings 44 of the two electrical devices 4, and thus the two different functional components 26, are electrically connected with the aid of particular plug-in jumper 52, a total of four plug-in jumpers 52 of this type being present.

In summary, one of pins 54 is guided into each of the four openings 38 of the rows facing each other and inserted into bushing 44 assigned in each case. Adjacent electrical devices 4 are each electrically connected to a total of four plug-in jumpers 52. For this purpose, each plug-in jumper 52 comprises U-shaped conductor 56, which is surrounded in each case by plastic body 50 of the two contact elements 48 outside housing 10. Plastic bodies 50 are designed in such a way that they also dip into particular opening 38, so that each plastic body 50 abuts sealing elements 40 assigned in each case.

Plastic bodies 50 are provided with a widened design on the outside of housing 10 and each have a projecting collar 58, which abuts housing 10 on the outside, namely cover element 42. A labyrinth seal is thus partially implemented there, and a sealing effect is improved with the aid of particular sealing element 40, by means of which particular opening 38 is lined. In the illustrated example, electrical devices 4, and thus also complete assembly 2, meets a protection classification according to IP 65 or IP 67, power connections 24 being correspondingly designed.

A latching tongue 60, which is formed on cover element 42, is assigned to each opening 38. Latching tongues 60 run perpendicularly to housing upper part 29 and point away therefrom. Particular contact element 48 is engaged from behind with the aid of latching tongues 60, so that particular contact element 48 is latched to housing 10. Plug-in jumper 52 is thus latched as a whole to two different housings 10, and contact elements 48 are each detachably held on assigned housing 10.

In the illustrated example, adjacent electrical devices are each connected with the aid of four plug-in jumpers 52, a different electrical potential being conducted by means of each of plug-in jumpers 52. The electrical potentials are provided by means of infeed module 6 during operation and conducted from there to each adjacent circuit breaker 8 via plug-in jumpers 52. The electrical potential is conducted from these circuit breakers 8 to each of the further adjacent circuit breakers 8, for which purpose one of bushings 44 of each printed circuit board 28 of the same circuit breaker 8 is electrically connected in each case to another in a low-resistance manner.

One of the total of eight sealing plugs 46 is inserted in each case into openings 38 of the two outer circuit breakers 8, which are situated on the outside and to which no further electrical device 4 is assigned. One of contact elements 48 is thus also inserted into each of these openings 38, which, however, are each formed in this case only by plastic body 50. They each also abut assigned sealing element 40 and are inserted into assigned bushing 44, so that each sealing plug 46 is secured against tilting. These contact elements 48, and thus sealing plugs 46, are also each latched with the aid of one of latching tongues 60, so that contact element 48 is fastened on housing 10. These plastic bodies 50 also each have collar 58, which abuts contact element 42 in a force-fitting manner, due to the latching with the aid of latching tongue 60, so that the labyrinth seal is also present here. As a result, the tightness is achieved also in the case of openings 38 which are not used for the further connection, due to sealing plugs 46. In other words, a tightness of assembly 2 is not impaired despite unused bushings 44. If a further electrical device 4 is to be mounted, the latter is arranged next to one of previously edge-side electrical devices 4, and its sealing plug 46 is removed and replaced in each case by a contact element 48 of a further plug-in jumper 52.

In summary, in the case of assembly 2, one of contact elements 48, which is either a constituent part of one of sealing plugs 46 or one of plug-in jumpers 52, is inserted into each of openings 38. Each contact element 48, namely particular plastic body 50, which has a different shape depending on whether contact element 48 is a constituent part of sealing plug 46 or plug-in jumper 52, abuts particular sealing element 40. Each plastic body 50 also has collar 58, which abuts particular housing 10 on the outside and which projects over particular opening 38, which are of the same design. In the case of assembly 2, functional components 26 of two adjacent electrical devices 4 are electrically connected with the aid of the four plug-in jumpers 52 assigned in each case, each of plug-in jumpers 52 including two of contact elements 48. Contact element 48 of each plug-in jumper 52 comprises in each case one of metallic pins 54, which is inserted in each case into one of openings 38 in the mounted state and is inserted on the end side into bushing 44 assigned in each case. Pins 54 of the same plug-in jumper 52 are formed by means of the same conductor 56 and are then electrically connected to each other outside housing 10.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An electrical device comprising:
a housing; and
a functional component arranged in the housing, the functional component comprising at least one bushing,
wherein the housing has an opening that covers the at least one bushing, and
wherein the opening is lined with a sealing element.

2. The electrical device according to claim 1, wherein a contact element is inserted into the opening and abuts the sealing element.

3. The electrical device according to claim 2, wherein the contact element has a plastic body, which abuts the sealing element.

4. The electrical device according to claim 2, wherein the contact element has a collar, which projects over the opening and abuts the housing on the outside.

5. The electrical device according to claim 2, wherein the contact element is held on the housing.

6. The electrical device according to claim 5, wherein the contact element is latched to the housing, the housing having a latching tongue, with the aid of which the contact element is engaged from behind.

7. The electrical device according to claim 1, wherein the sealing element is inserted into an indentation of a housing upper part and is covered by a cover element, which is fastened on the housing upper part.

8. The electrical device according to claim 7, wherein the housing upper part has a well, into which the indentation is introduced, and wherein the cover element is arranged in the well.

9. The electrical device according to claim 1, wherein the housing includes a housing shell, which comprises the opening and is closed with the aid of a cover, which is fastened on the housing shell.

10. An assembly comprising:
at least two electrical devices according to claim 1,
wherein two of the functional components are electrically connected via a plug-in jumper, which includes two contact elements, which each comprise a metallic pin that is guided in each case through one of the openings and is inserted on an end side into the bushing assigned in each case, and which are electrically connected to each other outside the housing.
